(19) United States
(12) Patent Application Publication
(10) Pub. No.: US 2024/0382940 A1
(43) Pub. Date: Nov. 21, 2024

(54) RESIN PRODUCTION METHOD, ULTRAPURE WATER PRODUCTION METHOD, AND ULTRAPURE WATER PRODUCTION APPARATUS

(71) Applicant: ORGANO CORPORATION, Tokyo (JP)

(72) Inventors: Tsukasa KONDO, Tokyo (JP); Fumitaka ICHIHARA, Tokyo (JP); Hiroshi SUGAWARA, Tokyo (JP)

(73) Assignee: ORGANO CORPORATION, Tokyo (JP)

(21) Appl. No.: 18/688,824

(22) PCT Filed: Aug. 8, 2022
(86) PCT No.: PCT/JP2022/030308

§ 371 Date: Mar. 4, 2024

(30) Foreign Application Priority Data
Sep. 8, 2021 (JP) 2021-146298

(51) Int. Cl. B01J 31/28; B01J 41/12; C02F 1/42

(52) U.S. Cl. CPC B01J 31/28; B01J 41/12; C02F 1/42; C02F 2001/422

(57) ABSTRACT

A new catalytic metal supporting resin production method that can streamline the purification process, and an ultrapure water production method that uses the catalytic metal supporting resin production method are provided. The method for producing a resin includes first filling a single vessel with first anion exchange resin that supports a catalytic metal and second anion exchange resin that does not support a catalytic metal and then purifying together first anion exchange resin and second anion exchange resin that fill the vessel. The ultrapure water production method includes reducing the amount of hydrogen peroxide or dissolved oxygen by causing water being treated that contains hydrogen peroxide or dissolved oxygen to come into contact with an ion exchange resin that contains at least the resin and that is produced by the resin production method.

### TECHNICAL FIELD

This application is based on Japanese Patent Application No. 2021-146298, filed on Sep. 8, 2021, and claims priority based on that application, which is incorporated herein by reference in its entirety.

The present invention relates to a resin production method, an ultrapure water production method, and an ultrapure water production apparatus that uses the resin produced by the resin production method.

### BACKGROUND ART

The irradiation by ultraviolet rays of water being treated to remove organic substances contained in the water is a known method. Irradiation by ultraviolet rays of the water being treated decomposes the water, generates hydroxyl radicals (OH⁻), and causes the hydroxyl radicals to react with organic substances to decompose the organic substances. When hydroxyl radicals do not react with organic substances and react with each other, hydrogen peroxide is generated. If ultrapure water containing hydrogen peroxide is supplied to a point of use (e.g., equipment for cleaning electronic components such as wafers), there is a possibility of damage to the wafers, and it is therefore desirable to remove as much excess hydrogen peroxide as possible. As a means for this purpose, a method is known in which the water being treated is brought into contact with an anion exchange resin that supports a catalytic metal such as palladium (hereinafter referred to as catalytic metal supporting resin) (Japanese Patent Application Laid-open No. 1985-71085). According to this method, the decomposition reaction of hydrogen peroxide (2H₂O₂→2H₂O+O₂) is facilitated by the catalytic action of the catalytic metal, and hydrogen peroxide can be efficiently removed.

### SUMMARY OF INVENTION

In a water treatment apparatus such as an ultrapure water production apparatus, anion exchange resins that do not support catalytic metals (hereinafter referred to as catalytic metal non-supporting resins) are also used. Conventionally, catalytic metal supporting resins and catalytic metal non-supporting resins are separate products and are therefore purified separately. Therefore, if both a catalytic metal supporting resin and a catalytic metal non-supporting resin are required, it is difficult to reduce the costs and the time required for their production.

An object of the present invention is to provide a new resin production method that can improve the efficiency of a purification process, and an ultrapure water production method that uses the resin produced by the resin production method.

The resin production method of the present invention comprises filling a single vessel with a first anion exchange resin that supports a catalytic metal and a second anion exchange resin that does not support a catalytic metal; and then purifying together the first anion exchange resin and the second anion exchange resin that fill the vessel.

The ultrapure water production method of the present invention reduces the amount of hydrogen peroxide or dissolved oxygen by bringing the water being treated that contains hydrogen peroxide or dissolved oxygen into contact with the resin produced by the above resin production method.

In the present invention, the first anion exchange resin and the second anion exchange resin that fill the vessel are purified together. Therefore, according to the present invention, it is possible to provide a new resin production method that can improve the efficiency of the purification process, and an ultrapure water production method that uses the resin production method.

The above-mentioned and other objects, features, and advantages of the present application will become apparent from the following detailed description taken in conjunction with the accompanying drawings that illustrate the present application.

### BRIEF DESCRIPTION OF DRAWINGS

FIG. 1 is a schematic diagram of a subsystem of an ultrapure water production apparatus according to an embodiment of the present invention.

FIG. 2A is a conceptual diagram showing a method for purifying and packing a catalytic metal supporting resin and a cation exchange resin in Comparative Example 1.

FIG. 2B is a conceptual diagram showing a method for purifying and packing a catalytic metal supporting resin and a cation exchange resin in Example 1.

### DESCRIPTION OF EMBODIMENTS

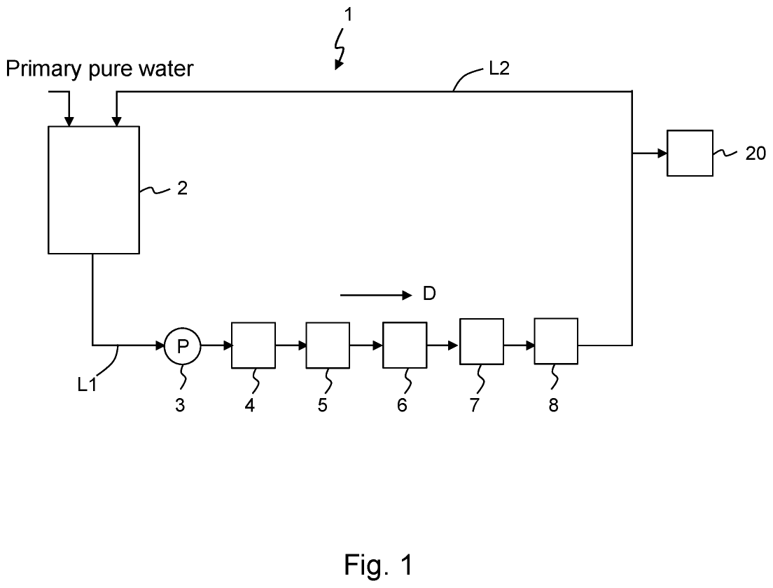

Embodiments of the present invention will be described below with reference to the drawings. FIG. 1 shows an outline of subsystem 1 of an ultrapure water production apparatus according to an embodiment of the present invention. Subsystem 1 is a system for producing ultrapure water to be supplied to point of use 20 from the pure water produced in the primary pure water system and is also called a secondary pure water system. Subsystem 1 comprises primary pure water tank 2, pure water supply pump 3, heat exchanger 4, ultraviolet oxidation device 5, ion exchange device 6, membrane deaerator 7, and ultrafiltration membrane device 8, and these components are arranged in series along the flow direction D of the water being treated in that order along main pipe L1. Main pipe L1 to point of use 20 also branches to connect to primary pure water tank 2 by return line L2 that returns ultrapure water not used at point of use 20 to primary pure water tank 2. Primary pure water tank 2 stores pure water produced by the primary pure water system. This pure water, that is, the water being treated in subsystem 1, may contain dissolved oxygen. According to the ultrapure water production method of the present embodiment, the amount of hydrogen peroxide or dissolved oxygen is reduced by causing ion exchange resin that contains at least catalytic metal supporting resin to come in contact with the water being treated that contains hydrogen peroxide or dissolved oxygen. The catalytic metal supporting resin is produced by the production method described below.

The water being treated stored in primary pure water tank 2 is pumped by pure water supply pump 3, temperature-adjusted by heat exchanger 4, and then supplied to ultraviolet oxidation device 5. Ultraviolet oxidation device 5 irradiates the water being treated with ultraviolet rays to decompose organic substances contained in the water. As ultraviolet irradiation device 5, for example, an ultraviolet lamp having at least one of wavelengths of 254 nm, 185 nm, and 172 nm can be used. When the water being treated is irradiated with ultraviolet rays, the water being treated produces hydroxyl radicals (OH⁻), and the hydroxyl radicals and organic substances react to decompose the organic substances. When hydroxyl radicals do not react with organic substances but instead react with each other, hydrogen peroxide is generated. In other words, the water being treated that is supplied to ion exchange device 6 is treated water that is obtained by irradiating water containing organic matter with ultraviolet rays to oxidize and decompose the organic matter and that further contains hydrogen oxide. Ion exchange device 6 will be described later.

Membrane deaerator 7 removes dissolved oxygen and carbon dioxide contained in the water being treated. The degassing process is performed, for example, by membrane degassing. In membrane degassing, the water being treated passes through one side of the degassing membrane, and the pressure on the other side is reduced by a vacuum pump, whereby dissolved oxygen and carbon dioxide in the water being treated passes through the degassing membrane and are removed from the water being treated. Ultrafiltration membrane device 8 is provided to remove particulates. Examples of ultrafiltration membrane device 8 include devices that use a membrane having a molecular weight cut-off of 4000 or more (for example, about 4000 to 6000). The ultrafiltration membrane is preferably one that elutes little from the membrane itself, and polysulfone can be suitably used. Ultrapure water, which is the water treated by ultrafiltration membrane device 8, is supplied to point of use 20.

Although not shown, when the water being treated contains dissolved oxygen, hydrogen may be added to the water being treated. Dissolved oxygen is removed by reacting oxygen with hydrogen to generate water using a catalytic metal. Since hydrogen only needs to be added before the water being treated is treated with the catalytic metal supporting resin, the hydrogenation equipment is provided upstream of ion exchange device 6.

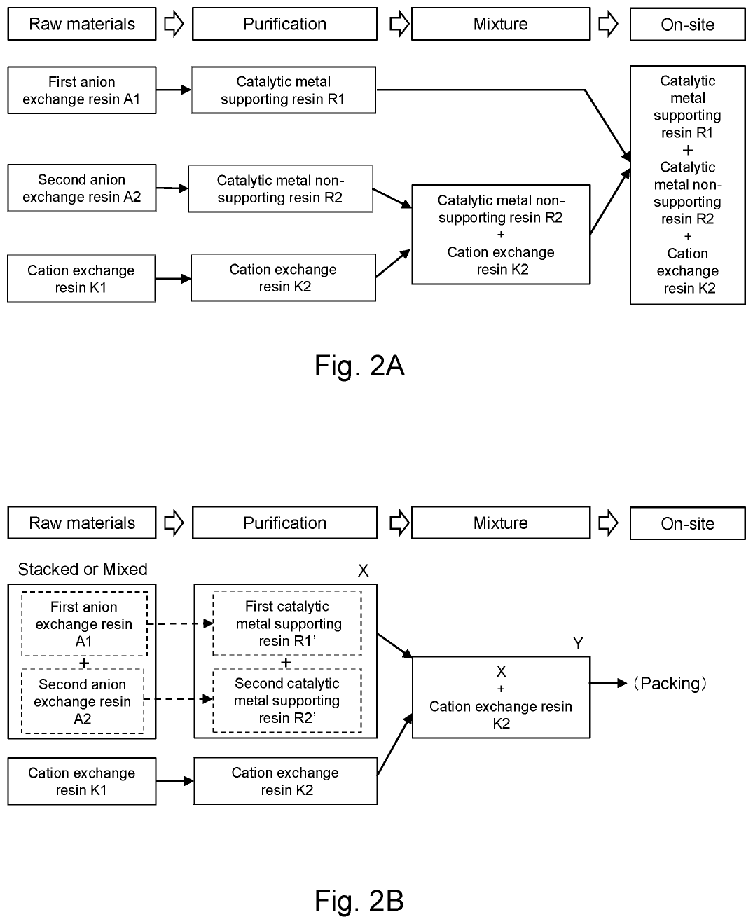

Ion exchange device 6 is filled with a catalytic metal supporting resin X and a cation exchange resin K2 (see FIG. 2B). The catalytic metal supporting resin X consists of first catalytic metal supporting resin R1′ and second catalytic metal supporting resin R2′. In the following description, first catalytic metal supporting resin R1′ (Example), second catalytic metal supporting resin R2′ (Example), catalytic metal supporting resin R1 (Comparative Example), and catalytic metal non-supporting resin R2 (Comparative Example) are individual resin particles. First catalytic metal supporting resin R1′ is an anion exchange resin that supports a catalytic metal capable of decomposing hydrogen peroxide. First catalytic metal supporting resin R1′ decomposes hydrogen peroxide generated by ultraviolet irradiation and removes anion components. Examples of the catalytic metal include platinum group metals such as palladium (Pd) and platinum (Pt). The base resin of second catalytic metal supporting resin R2′ is preferably substantially the same as or the same as that of first catalytic metal supporting resin R1′. Second catalytic metal supporting resin R2′ may include resin particles that support a catalytic metal capable of decomposing hydrogen peroxide, and resin particles that do not support a catalytic metal capable of decomposing hydrogen peroxide. However, the proportion of resin particles that do not support a catalytic metal is usually higher than that of first catalytic metal supporting resin R1′. Like first catalytic metal supporting resin R1′, second catalytic metal supporting resin R2′ decomposes hydrogen peroxide generated by ultraviolet irradiation device 5 and removes anion components. Cation exchange resin K2 removes cation components. A catalytic metal capable of decomposing hydrogen peroxide is not supported on cation exchange resin K2. The flow rate of ion exchange device 6 is preferably set so that the water being treated is brought into contact with catalytic metal supporting resin X at a water flow space velocity of 30 (/hr) or more and 2000 (/hr) or less, whereby hydrogen peroxide can be efficiently removed while ensuring a processing flow rate. The hydrogen peroxide concentration in the treated water treated with catalytic metal supporting resin X is reduced to 5 μg/L (ppb) or less.

The production method and packing method of first catalytic metal supporting resin R1′, second catalytic metal supporting resin R2′, and cation exchange resin K2 will next be described. First catalytic metal supporting resin R1′ is made by purifying first anion exchange resin A1, which supports a catalytic metal capable of decomposing hydrogen peroxide. Second catalytic metal supporting resin R2′ is made by purifying second anion exchange resin A2. In the purification process, an acidic solution is passed through water, and an alkaline solution is then passed through the water. Impurities such as organic substances eluted from first and second anion exchange resins A1 and A2 are below a set value (target value), and the total anion exchange is performed using first anion exchange resin A1 and second anion exchange resin A2. When the ratio of the OH type to the total exchange capacity of the resin is equal to or higher than a set value (target value), variables such as the concentrations of the acidic solution and the alkaline solution, and the liquid passage speed, the liquid passage time can be set as appropriate. As the acidic solution, for example, HCL or HNO₃ can be used. As the alkaline solution, for example, NaOH or TMAH (tetramethylammonium hydroxide) can be used. It is preferable that first anion exchange resin A1 and second anion exchange resin A2 have substantially the same base resin. The condition that the base resins be substantially the same means that the raw materials of the base resins are the same and the basic physical properties are the same, whereby, when mixing first anion exchange resin A1 and second anion exchange resin A2, the two resins can be easily mixed uniformly and uniform quality can be maintained. In particular, resins of the same brand are preferably used as the base resins of first anion exchange resin A1 and second anion exchange resin A2.

First and second anion exchange resins A1 and A2 may be, for example, of a porous type or an MR type but are preferably of a gel type from which organic substances are less eluted. At least one of first anion exchange resin A1 and second anion exchange resin A2 may be of the Cl type before purification (that is, at the time of packing the purification vessel). This is because anion exchange resins are generally distributed of the Cl type. Both first anion exchange resin A1 and second anion exchange resin A2 may be of the Cl type before purification, whereby first anion exchange resin A1 and second anion exchange resin A2 can be purified in the same process, making it possible to further rationalize the entire process. Further, both first anion exchange resin A1 and second anion exchange resin A2 may be of the OH type before purification.

In this embodiment, 70% or more, preferably 90% or more, and more preferably 95% or more of the total exchange capacity of all the anion exchange resins including first anion exchange resin A1 and second anion exchange resin A2 is converted into the OH type after purification. Since OH type first catalytic metal supporting resin R1′ and second catalytic metal supporting resin R2′ easily contact with H₂O₂, the H₂O₂ decomposition and removal performance is improved. The amount of catalytic metal supported on first anion exchange resin A1 is preferably 10 mg-catalyst/L-R (this expression indicates the amount of catalyst per liter of the anion exchange resin, and “R” indicates that this is an anion exchange resin based on the OH type) or more and 500 mg-catalyst/L-R or less.

FIG. 2A is a conceptual diagram showing the purification method and packing method of catalytic metal supporting resin R1, catalytic metal non-supporting resin R2, and cation exchange resin K2 in Comparative Example 1 (conventional example), and FIG. 2B is a conceptual diagram showing the purification method and packing method of metal supporting resin R1′, second catalytic metal supporting resin R2′, and cation exchange resin K2 in Example 1.

In Comparative Example 1, catalytic metal supporting resin R1, catalytic metal non-supporting resin R2, and cation exchange resin K2 are produced separately. That is, first anion exchange resin A1 that supports a catalytic metal capable of decomposing hydrogen peroxide, second anion exchange resin A2 that does not support a catalytic metal capable of decomposing hydrogen peroxide, and cation exchange resin K1 are separately supplied to a purification vessel, each having been purified at the factory. First anion exchange resin A1 is of the Cl type and is changed to the OH type by purification to become catalytic metal supporting resin R1. Second anion exchange resin A2 is of the Cl type and is changed to the OH type by purification to become catalytic metal non-supporting resin R2. Cation exchange resin K1 is of the Na type and is changed to the H type by purification to become cation exchange resin K2. Thus, purification is a process that involves changing the type of the ions in the ion exchange groups of the resin.

Next, a mixing process is performed. In the mixing process, catalytic metal non-supporting resin R2 and cation exchange resin K2 are mixed. Catalytic metal supporting resin R1 is shipped as a product and is not mixed. On-site, ion exchange device 6 is filled with the mixed resin of catalytic metal non-supporting resin R2 and cation exchange resin K2, following which catalytic metal supporting resin R1 is packed in ion exchange device 6. As a result, the lower part of ion exchange device 6 is filled with the mixed resin of catalytic metal non-supporting resin R2 and cation exchange resin K2, and catalytic metal supporting resin R1 is layered above the mixed resin.

On the other hand, in Example 1, first anion exchange resin A1 that supports a catalytic metal and second anion exchange resin A2 that does not support a catalytic metal have been packed in the same purification vessel beforehand before shipment. Although first anion exchange resin A1 and second anion exchange resin A2 may be mixed, first anion exchange resin A1 is preferably stacked on second anion exchange resin A2. This form is preferred because catalytic metal detached from first anion exchange resin A1 falls due to gravity and will likely re-attach to second anion exchange resin A2. When first anion exchange resin A1 and second anion exchange resin A2 are mixed, the timing of mixing may be any time before the start of purification, and may be performed before or after being packed in the purification vessel.

In the purification process, these stacked or mixed resins change from the Cl type to the OH type, whereby a new catalytic metal supporting resin X is produced. That is, first anion exchange resin A1 and second anion exchange resin A2 that are packed in the purification vessel are purified together, thereby producing catalytic metal supporting resin X consisting of first catalytic metal supporting resin R1′ and second catalytic metal supporting resin R2′. Specifically, first anion exchange resin A1 that supports catalytic metal is purified to become first catalytic metal supporting resin R1′, but some of the metal catalyst is removed from the resin constituting first catalytic metal supporting resin R1′. Further, second anion exchange resin A2 is purified to become second catalytic metal supporting resin R2′, but the metal catalyst detached from first anion exchange resin A1 is re-supported on the resin constituting second catalytic metal supporting resin R2′. Thus, the catalytic metal supporting resin X of Example 1 is a novel catalytic metal supporting resin that differs from the mixture of catalytic metal supporting resin R1 and catalytic metal non-supporting resin R2 of Comparative Example 1. Cation exchange resin K1 changes from the Na type to the H type through purification to become cation exchange resin K2, and this process is the same as in Comparative Example 1. In the mixing process, new catalytic metal supporting resin X and cation exchange resin K2 are mixed to produce new mixed resin Y, and mixed resin Y is packed into ion exchange device 6 on-site.

Table 1 shows a comparison of Example 1 and Comparative Example 1 regarding purification of an anion exchange resin. The water consumption is the amount of pure water used for, for example, cleaning, the chemical consumption is the amount of chemicals used for purification, the time required is the total time required for purification, and the cost is the total cost required for purification, all values having been standardized by taking the values in Comparative Example 1 as 1. In Comparative Example 1, each of first anion exchange resin A1 and second anion exchange resin A2 was purified, and the purification was carried out a total of two times. Since catalytic metal supporting resin R1 is in less demand than catalytic metal non-supporting resin R2, the amount of purification of first anion exchange resin A1 may be smaller than the amount of purification of second anion exchange resin A2, and the amount of purification of first anion exchange resin A1 was therefore set to 1/6 of the amount of purification of second anion exchange resin A2. In Example 1, the mixed resin of first anion exchange resin A1 and second anion exchange resin A2 was purified only once. The total amount of purification of first anion exchange resin A1 and second anion exchange resin A2 was the same as the amount of purification of second anion exchange resin A2 of Comparative Example 1. For all indicators, Example 1 showed better results than Comparative Example 1.

TABLE 1

| | Water | Chemical | Time | | Risk of | Quality |
|---|---|---|---|---|---|---|
| | Consumption | Consumption | Required | Cost | Contamination | Control |
| Comparative | 1 | 1 | 1 | 1 | High | Difficulty |
| Example | | | | | | |
| Example | 0.54 | 0.71 | 0.65 | 0.54 | Low | Easy |

Furthermore, usage of the same equipment for purifying catalytic metal supporting resin R1 and catalytic metal non-supporting resin R2 results in the following problems. Industrially, the use of large-scale equipment to purify resin is advantageous from the viewpoints of efficiency, quality, and cost. However, as described above, the demand for catalytic metal supporting resin R1 is low, so the amount of catalytic metal supporting resin R1 produced in one purifying process is less than the rated capacity of the purifying equipment. For this reason, the layer height of first anion exchange resin A1 decreases, and the amount of passage of water therefore may vary depending on the location. In other words, there is a possibility that, depending on the location, purification defects may occur such as insufficient supply of chemicals or washing water to a portion of the resin layer. One possible solution is to reduce the amount of chemicals or washing water (or space velocity SV or linear velocity LV of water flow), but this would mean using the purification equipment in a way different from the original usage, with the result that quality control of the purification process becomes difficult. This problem can be solved by producing catalytic metal supporting resin R1 in an amount comparable to the rated capacity of the purifying equipment, but this approach raises the possibility that the inventory of catalytic metal supporting resin R1 will increase. Although it is possible to provide purifying equipment of the optimal scale for the required amount (market scale) of catalytic metal supporting resin R1, the cost pf equipment investment will increase.

On the other hand, in Example 1, an anion resin containing first anion exchange resin A1 and second anion exchange resin A2 at a desired ratio is purified. As mentioned above, since the purification processes of first anion exchange resin A1 and second anion exchange resin A2 are the same, the same purification process can be applied to a resin obtained by stacking or mixing first anion exchange resin A1 and second anion exchange resin A2. Since this resin is produced in an amount comparable to the rated capacity of the purifying equipment, problems regarding quality control and inventory are also eliminated.

In the comparative example, catalytic metal non-supporting resin R2 and cation exchange resin K2 are mixed and then packed, following which catalytic metal supporting resin R1 is packed. However, the increase of mixing and packing processes may impair the cleanliness of the resin. To solve this problem, it is desirable to simplify the work in each process as much as possible. In this embodiment, since the packing operation need only be performed once, the possibility of contamination of the resin is also reduced.

Furthermore, in the comparative example, a part of the metal catalyst is desorbed from first anion exchange resin A1 during the purification process and is discharged outside the system. However, platinum group metal catalysts are expensive and have a large impact on cost. In contrast, in Example 1, the portion of the metal catalyst that is desorbed from first anion exchange resin A1 as described above is re-supported on second anion exchange resin A2 that does not support the metal catalyst, whereby expensive metal catalysts can be used effectively.

The characteristics of the catalytic metal supporting resin R 1 and the catalytic metal supporting resin X produced by the above method were next checked using a test device equivalent to the test device shown in FIG. 1. First anion exchange resin A1 that supports a metal catalyst on a Cl type anion exchange resin and second anion exchange resin A2 that is the same metal catalyst supporting resin A but that does not support a metal catalyst were prepared. In Example 2, first anion exchange resin A1 and second anion exchange resin A2 were packed into the same column (corresponding to the above-mentioned purification vessel) and purified. In Comparative Example 2, only first anion exchange resin A1 was packed into a column and purified. In Table 2, R-OH is the proportion occupied by the OH type. In other words, R-OH is an index indicating the proportion of purification performed. The amount of catalyst supported is the weight of the metal catalyst supported by all the anion exchange resins in the column after purification. The H₂O₂ removal performance indicates the concentrations of H₂O₂ at the column inlet and column outlet when the water being treated containing H₂O₂ is passed through the column. It was confirmed that in Example 2 both the purification efficiency (R-OH) and the quality were improved. Example 2 was also superior with respect to the amount of catalyst supported. It is believed these results were obtained because a part of the metal catalyst desorbed from first anion exchange resin A1 was re-supported on second anion exchange resin A2. The H₂O₂ removal performance was equivalent for Example 2 and Comparative Example 2.

TABLE 2

| | Comparative | |
|---|---|---|
| | Example 2 | Example 2 |
| R-OH (%) | 93.6 | 95.8 |
| Amount of catalytic | 94.9 | 98.2 |
| supporting (mg/L-R) | | |
| Removal performance | Column Inlet: 27 | Column Inlet: 27 |
| of H₂O₂ (μg/L) | Column Outlet: <1 | Column Outlet: <1 |

While several preferred embodiments of the invention have been shown and described in detail, it will be understood that various changes and modifications can be made without departing from the spirit or scope of the appended claims.

### Reference Signs List

1: Subsystem
2: Primary pure water tank
3: Pure water supply pump
4: Heat exchanger
5: Ultraviolet oxidation device
6: Ion exchange device
7: Membrane deaerator
8: Ultrafiltration membrane device
20: Point of use
A1: First anion exchange resin (Cl type)
A2: Second anion exchange resin (Cl type)
K1: Cation exchange resin (Na type)
K2: Cation exchange resin (H type)
R1: Catalytic metal supporting resin (OH type) (Comparative Example)
R1′: First catalytic metal supporting resin (OH type) (Example)
R2: Catalytic metal non-supporting resin (OH type) (Comparative Example)
R2′: Second catalytic metal supporting resin (OH type) (Example)
X: Catalytic metal supporting resin

1. A resin production method comprising:
filling a single vessel with a first anion exchange resin that supports a catalytic metal and a second anion exchange resin that does not support a catalytic metal; and
purifying together said first anion exchange resin and said second anion exchange resin that fill said vessel.

2. The resin production method according to claim 1, wherein said first anion exchange resin is stacked on said second anion exchange resin.

3. The resin production method according to claim 1, wherein at least one of said first anion exchange resin and said second anion exchange resin is of Cl type before purification.

4. The resin production method according to claim 1, wherein said first anion exchange resin and said second anion exchange resin have substantially a same base resin.

5. The resin production method according to claim 1, wherein said catalytic metal is a platinum group metal having hydrogen peroxide decomposition ability, and the amount of said catalytic metal supported on said first anion exchange resin is 10 mg-catalyst/L-R or more and 500 mg-catalyst/L-R or less.

6. The resin production method according to claim 1, wherein during purification, a part of said catalytic metal is desorbed from said first anion exchange resin, and said desorbed catalytic metal is re-supported on said second anion exchange resin.

7. An ultrapure water production method comprising:
reducing the amount of hydrogen peroxide or dissolved oxygen by causing water being treated that contains hydrogen peroxide or dissolved oxygen to come into contact with an ion exchange resin that contains at least a catalytic metal supporting resin and that is produced by the resin production method according to claim 1.

8. An ultrapure water production apparatus comprising an ion exchange device filled with an ion exchange resin, the ion exchange resin containing at least a resin produced by the resin production method according to claim 1.
